(19) United States
(12) Patent Application Publication
(10) Pub. No.: US 2022/0347791 A1
(43) Pub. Date: Nov. 3, 2022

(54) LASER PROCESSING APPARATUS, THICKNESS DETECTION METHOD, AND THICKNESS DETECTION APPARATUS

(71) Applicant: Nagoya Institute of Technology, Nagoya-Shi, Aichi (JP)

(72) Inventors: Fumihiro Itoigawa, Nagoya-Shi, Aichi (JP); Osamu Konda, Nagoya-Shi, Aichi (JP); Sho Fujiwara, Nagoya-Shi, Aichi (JP); Shotaro Yasuda, Nagoya-Shi, Aichi (JP)

(21) Appl. No.: 17/761,243

(22) PCT Filed: Feb. 26, 2021
(86) PCT No.: PCT/JP2021/007288

§ 371 Date: Mar. 17, 2022

(51) Int. Cl. B23K 26/03; B23K 26/38; B23K 26/06; B23K 26/402

(52) U.S. Cl. CPC B23K 26/032; B23K 26/38; B23K 26/0648; B23K 26/402

(57) ABSTRACT

Provided is a laser processing apparatus configured to machine a corner portion of a machining target object by causing the corner portion to be relatively displaced toward a laser, the laser having an optical axis extending in a predetermined direction, the corner portion being formed by a plurality of adjacent surfaces of the machining target object and including a coating layer comprising a light-transmissive material, the laser processing apparatus including: displacement control means for controlling an actuator such that the machining target object becomes relatively close to or away from the optical axis; a detection unit provided at a position at least outside an irradiation region of the laser, the irradiation region extending in a tubular shape in a plan view intersecting the optical axis, the detection unit being configured to detect intensity of light reaching the position; and detection means for detecting a distance of relative displacement of the machining target object between points of detection of a first intensity and a third intensity as a thickness of the coating layer in a case where the predetermined first intensity, a second intensity smaller than the first intensity, and the third intensity larger than the first intensity are detected in order by the detection unit while the machining target object becomes relatively close to or away from the optical axis.

### TECHNICAL FIELD

The present invention relates to a laser machining apparatus that performs laser machining.

### BACKGROUND ART

In recent years, a technique has been proposed with which a cylindrical irradiation region extending in the optical axis direction of a laser is displaced in a direction intersecting the optical axis to form a machining surface on the surface side of a machining target object through which the irradiation region passes (Patent Document 1). This machining method is an excellent machining method in that mechanical damage can be reduced and a machining surface can be smoothly formed as compared with mechanical machining methods.

### CITATION LIST

### Patent Document

Patent Document 1: JP 6562536 B2

### SUMMARY OF THE INVENTION

### Problem to be Solved by the Invention

This type of machining method is also used in machining a corner portion in a machining target object formed by a plurality of adjacent surfaces, examples of which include a cutting tool having a corner portion formed by a rake surface and a flank surface. Specifically, laser irradiation is performed such that the optical axis extends along the direction of spread of the rake surface or the flank surface and the laser is displaced to form a new rake or flank surface in the corner portion as a machining surface or form a shape for a specific purpose such as an edge and unevenness.

In addition, although the hardness of the machining target object is enhanced by forming a coating layer such as a diamond coating on the corner portion, it is necessary to check in advance whether the coating layer has an appropriate thickness in forming a machining surface or imparting a function to such a coating layer.

However, the thickness of the coating layer is required to be measured by setting the machining target object in a measuring device for that purpose and set again in a laser machining apparatus after confirming that the coating layer has an appropriate thickness. In the related art, there is a problem that the work up to the actual machining is complicated.

The invention has been made to solve such a problem, and an object thereof is to provide a technique for easily checking the thickness of a coating layer formed on a machining target object.

### Means for Solving Problem

A first aspect for solving the above problem is a laser processing apparatus configured to perform laser machining on a corner portion of a machining target object by causing the corner portion to be relatively displaced toward a laser, the laser being emitted such that an optical axis of the laser extends in a predetermined direction, the corner portion being formed by a plurality of adjacent surfaces of the machining target object and including a coating layer comprising a light-transmissive material, the laser processing apparatus including: displacement control means for controlling an actuator to relatively displace the machining target object along a direction intersecting the optical axis with respect to the laser such that the machining target object becomes relatively close to or away from the optical axis; a detection unit provided at a position at least outside an irradiation region of the laser, the irradiation region extending in a tubular shape in a plan view intersecting the optical axis, the detection unit being configured to detect intensity of light reaching the position; and detection means for detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection unit while the machining target object becomes relatively close to or away from the optical axis.

This first aspect may be as described in the following second aspect.

In the second aspect, the detection unit is provided at the position at least outside the irradiation region extending in the tubular shape in the laser in the plan view intersecting the optical axis with the position in a region opposite to the irradiation unit in a case where a space extending along the optical axis is divided into two by the machining target object.

A third aspect for solving the above problem is a thickness detection method including: a displacement control procedure of causing a machining target object to become relatively close to or away from an optical axis of a laser, the laser being emitted such that the optical axis of the laser extends in a predetermined direction in a state where a corner portion of the machining target object is directed to the laser side, the corner portion being formed by a plurality of adjacent surfaces of the machining target object and including a coating layer comprising a light-transmissive material; a detection procedure of detecting intensity of light reaching a position at the position at least outside an irradiation region of the laser, the irradiation region extending in a tubular shape in a plan view intersecting the optical axis and; and a detection procedure of detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection procedure while the machining target object becomes relatively close to or away from the optical axis.

A fourth aspect for solving the above problem is a thickness detection apparatus including: an irradiation unit configured to emit a laser such that an optical axis of the laser extends in a predetermined direction; an actuator configured to relatively displace a machining target object along a direction intersecting the optical axis with respect to the laser in a state where a corner portion of the machining target object is directed to the laser, the corner portion being formed by a plurality of adjacent surfaces of the machining target object and including a coating layer comprising a light-transmissive material; displacement control means for controlling the actuator such that the machining target object becomes relatively close to or away from the optical axis; a detection unit provided at a position at least outside an irradiation region of the laser, the irradiation region extending in a tubular shape in a plan view intersecting the optical axis and detecting intensity of light reaching the position; and detection means for detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection unit while the machining target object becomes relatively close to or away from the optical axis.

### Effect of the Invention

In each of the above aspects, in a case where the first intensity, the second intensity, and the third intensity are detected in order in the process of the optical axis and the machining target object becoming close to or away from each other, the relative displacement distance between the point of the first intensity (first point) and the point of the third intensity (third point) is the thickness of the coating layer. In the above aspect, the thickness of the coating layer can be detected based on the transition of the light intensity and the relative displacement distance of the machining target object.

In each of the above aspects, the transition of the light intensity and the relative displacement distance of the machining target object can be specified based on the function of the laser machining apparatus, and thus the thickness of the coating layer can be confirmed without resetting the machining target object in a measuring device for that purpose. As a result, the work up to the actual machining can be simplified.

### BRIEF DESCRIPTION OF DRAWINGS

FIG. 1 is a block diagram illustrating an overall configuration of a laser machining apparatus;

FIG. 2 is a block diagram illustrating a configuration of an irradiation unit;

FIG. 3 is a diagram illustrating a positional relationship between a laser irradiation region and a detection unit;

FIG. 4 is a flowchart illustrating a thickness detection processing procedure;

FIG. 5 is a diagram illustrating how a machining target object approaches the optical axis of a laser; and

FIG. 6 is a graph illustrating a transition of light intensity detected by the detection unit.

### MODE(S) FOR CARRYING OUT THE INVENTION

An embodiment for carrying out the invention will be described in detail with reference to the drawings.

(1) Apparatus Configuration

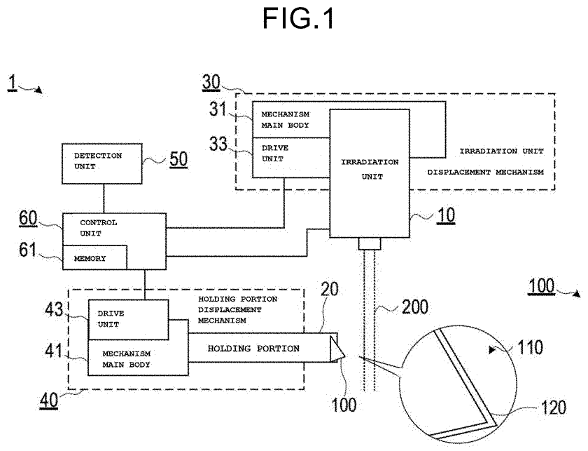

As illustrated in FIG. 1, a laser machining apparatus 1 includes an irradiation unit 10 performing laser irradiation such that an optical axis extends in a predetermined direction (up-down direction in FIG. 1), a holding portion 20 for holding a machining target object 100, an irradiation unit displacement mechanism 30 for displacing the irradiation unit 10 with respect to the machining target object 100, a holding portion displacement mechanism 40 for displacing the holding portion 20 with respect to the laser, a detection unit 50 detecting the intensity of light at a predetermined position, and a control unit 60 controlling the operation of the entire laser machining apparatus 1.

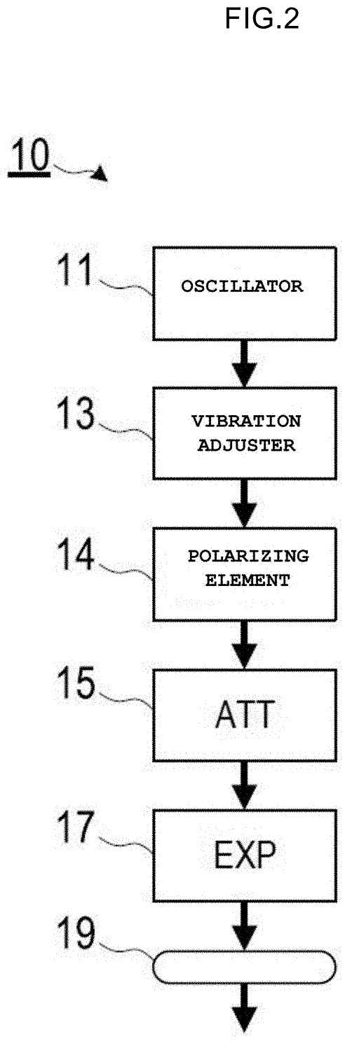

As illustrated in FIG. 2, the irradiation unit 10 includes, for example, an oscillator 11 outputting a pulsed laser, a vibration adjuster 13 adjusting the order of the frequency of the laser, a polarizing element 14 performing polarization state adjustment, an attenuator (ATT) 15 performing laser output adjustment, and a beam expander (EXP) 17 for laser diameter adjustment. The irradiation unit 10 is configured such that the laser passing through the components is output via an optical lens 19 and performs laser irradiation with the optical axis directed in a predetermined direction (Z-axis direction in the present embodiment). An Nd:YAG pulsed laser is used for the oscillator 11. The above configuration includes the single optical lens 19. An alternative configuration may include a set of optical lenses disposed at predetermined intervals and a mechanism for adjusting the distance between the optical lenses.

The holding portion 20 is a rod-shaped member extending in a direction intersecting the optical axis of the laser (left-right direction in FIG. 1) and is configured so as to be capable of holding the machining target object 100 at the tip of the holding portion 20. The machining target object 100 is held in a positional relationship in which an end portion of the machining target object 100 protrudes from the tip of the holding portion 20.

The irradiation unit displacement mechanism 30 includes a mechanism main body 31 as an actuator displaced in a predetermined direction with the irradiation unit 10 attached and a drive unit 33 operating the mechanism main body 31 based on a command from the outside. In the present embodiment, the mechanism main body 31 is configured to displace the irradiation unit 10 in a direction intersecting the optical axis of the laser (direction from the front to the back of the paper surface in FIG. 1).

The holding portion displacement mechanism 40 includes a mechanism main body 41 as an actuator displaced in a predetermined direction with the holding portion 20 attached and a drive unit 43 operating the mechanism main body 41 based on a command from the outside. In the present embodiment, the mechanism main body 41 is configured to displace the holding portion 20 in the direction in which the holding portion 20 extends.

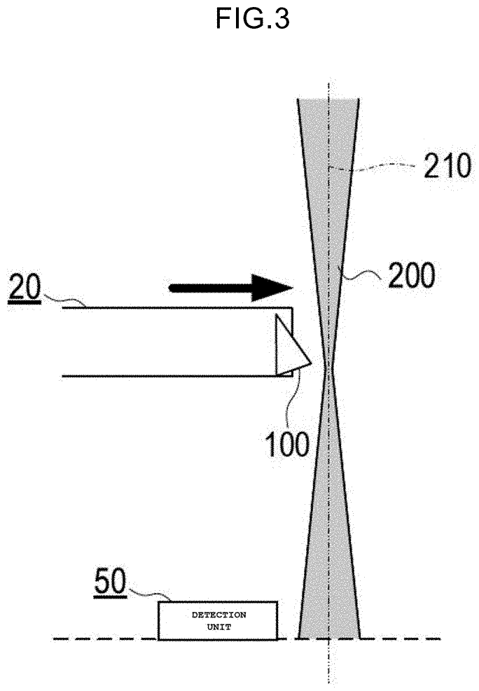

As illustrated in FIG. 3, the detection unit 50 is an optical sensor provided at a position at least outside an irradiation region 200 when viewed from a plane intersecting an optical axis 210 (plane of the broken line in FIG. 3) with the position in the region opposite to the irradiation unit 10 in a case where the space extending along the optical axis 210 is divided into two by the machining target object 100 (region below the holding portion 20 in FIG. 3). The detection unit 50 detects the intensity of light that reaches this position (hereinafter, also referred to as “light intensity”). In the present embodiment, a line sensor in which a plurality of light receiving elements are disposed in a direction away from the optical axis 210 is adopted as the detection unit 50. The detection unit 50 is disposed at a position that diffracted light is capable of reaching with sufficient intensity in the thickness detection processing to be described later.

The control unit 60 is a computer controlling, for example, the laser irradiation that is performed by the irradiation unit 10, the displacement of the irradiation unit 10 that is performed by the irradiation unit displacement mechanism 30, and the displacement of the holding portion 20 that is performed by the holding portion displacement mechanism 40 by means of control commands to the respective parts.

As for the machining target object 100, a corner portion 110 is formed by a plurality of adjacent surfaces. In the present embodiment, the machining target object 100 is a cutting tool made of cemented carbide that does not transmit light, one surface of the tool is a rake surface, and the other is a flank surface.

Also used as the machining target object 100 is one in which a coating layer 120 made of a highly light-transmissive material is formed on the corner portion 110. As a specific example, a light-transmitting diamond coating is used as the coating layer 120. In this example, the cemented carbide that is the material of the machining target object 100 does not transmit light, and thus the coating layer 120 formed of the diamond coating is more light-transmissive than the corner portion 110 itself.

By installing the machining target object 100 in a positional relationship in which the corner portion 110 is directed toward the laser irradiation region 200 side, the surface formed by the corner portion 110 is inclined with respect to the optical axis 210.

As for the laser machining apparatus 1 configured as described above, a machining surface can be formed on the corner portion 110 by performing laser irradiation such that the optical axis extends along the plane direction formed by the corner portion 110 and displacing the laser.

(2) Procedure of Processing by Control Unit 60

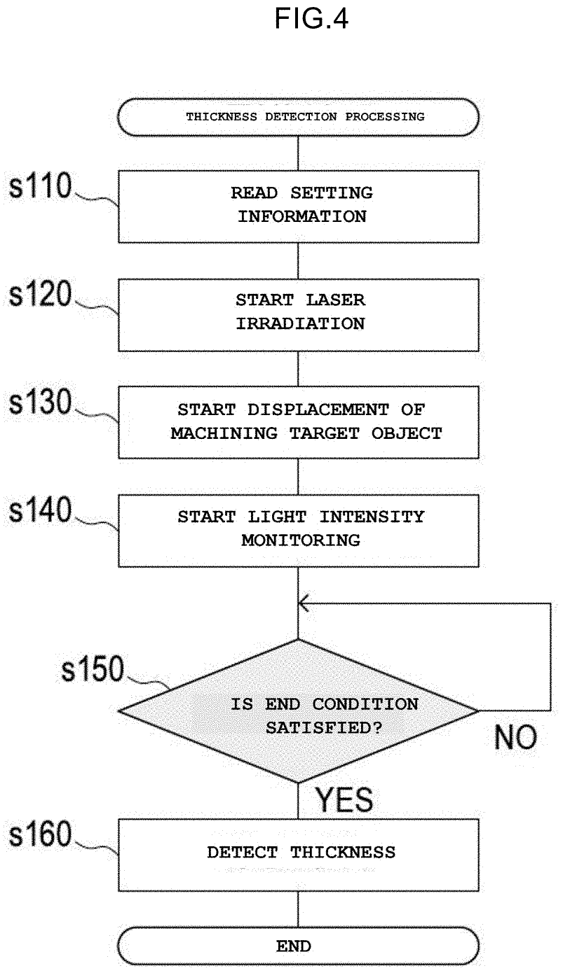

Hereinafter, the procedure of “thickness detection processing” that the control unit 60 executes with a program stored in a built-in memory 61 will be described with reference to FIG. 4. This thickness detection processing is executed after the machining target object 100 where the coating layer 120 is formed is held by the holding portion 20 and positioned and is started when a start command is received from an interface (operation device or communication device, not illustrated).

When this machining processing is started, first, setting information pre-stored in the built-in memory 61 is read (s110). This setting information is information preset by a user and includes an output PO [w] of the laser emitted by the irradiation unit 10, a machining threshold Pth [w] corresponding to the material properties of the machining target object 100 installed in the holding portion 20, and coordinate information defining the optical axis 210. Here, the output level PO of the laser is set to a value smaller than the machining threshold Pth for thickness detection (P0<Pth).

Next, laser irradiation by means of the irradiation unit 10 is started (s120). Here, the irradiation unit 10 starts the laser irradiation with an instruction received from the control unit 60.

Next, the displacement of the machining target object 100 to the optical axis 210 side of the laser emitted by the irradiation unit 10 is started (s130). Here, a control command is given to the holding portion displacement mechanism 40 such that the holding portion 20 is displaced toward the optical axis 210 and, in response to the control command, the holding portion displacement mechanism 40 starts the displacement of the machining target object 100 to the optical axis 210 side. In this manner, the machining target object 100 is displaced by a predetermined unit distance for each unit time.

Next, monitoring of the light intensity detected by the detection unit 50 is started (s140). Here, the light intensity detected at each point reached by the unit distance displacement is acquired and recorded. In the present embodiment, the total value or the averaged value of the light intensities (W) respectively output from the light receiving elements of the line sensor adopted as the detection unit 50 is detected as the light intensity at that point.

Next, it is checked whether or not the end condition of this thickness detection processing is satisfied (s150). Here, for example, it is determined that the end condition is satisfied when the light intensity is equal to or less than an end threshold determined as the end condition over a certain distance (e.g. several times the unit distance) or the tip of the machining target object 100 has reached an end position determined as the end condition (e.g. position of the optical axis 210).

Next, a standby state is maintained until the end condition of this thickness detection processing is satisfied (s150: NO), during which the transition of the light intensity for each point reached by the unit distance displacement is recorded.

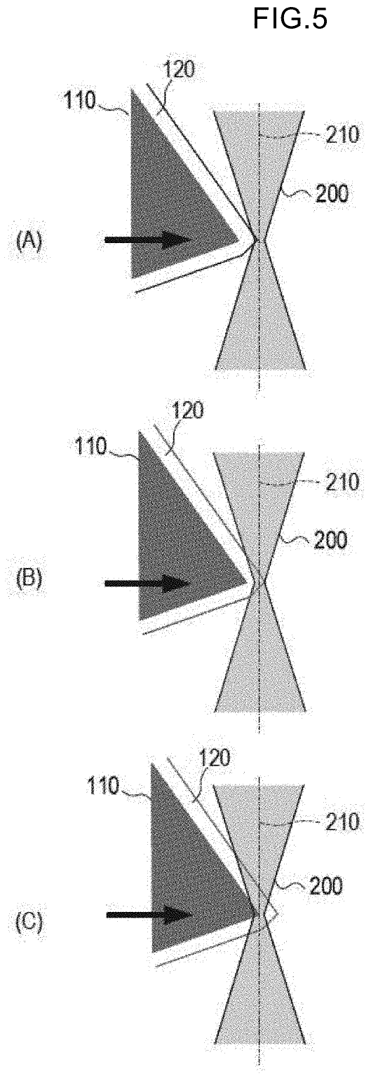

Here, in the process in which the machining target object 100 approaches the optical axis 210 of the laser, the machining target object 100 passes through a first point (FIG. 5(A)) where the laser irradiation region 200 reaches the surface of the coating layer 120 formed on the corner portion 110, a second point (FIG. 5(B)) where the irradiation region 200 overlaps the coating layer 120, and a third point (FIG. 5(C)) where the irradiation region 200 reaches the surface of the main body of the machining target object 100 as illustrated in FIG. 5.

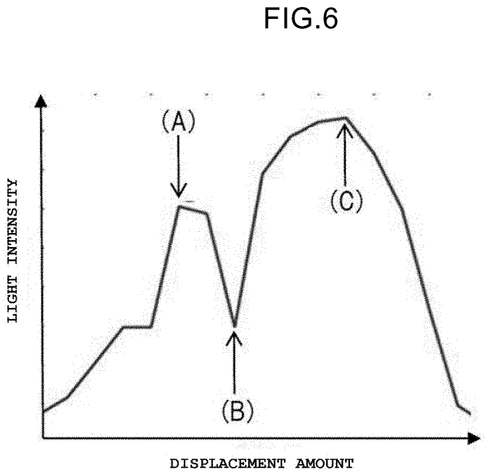

Of these three points, first, at the first point, diffracted light or the like that wraps around the surface of the coating layer 120 reaches the outside of the irradiation region 200, and yet the coating layer 120 transmits light, and thus the light intensity (first intensity) is smaller than at the third point to be described later (see (A) in FIG. 6). Next, at the second point, light easily passes through the coating layer 120, diffracted light is unlikely to be generated, and thus the intensity of light reaching the outside of the irradiation region 200 (second intensity) is smaller than at the first point (see (B) in FIG. 6). Further, at the third point, diffracted light that wraps around the surface of the main body of the machining target object 100 reaches the outside of the irradiation region 200, the main body of the machining target object 100 hardly transmits light, and thus the intensity of light reaching the outside of the irradiation region 200 (third intensity) is higher than at any point (see (C) in FIG. 6).

In other words, in a case where the first intensity, the second intensity, and the third intensity are detected in order in the process of the optical axis 210 and the machining target object 100 approaching each other, the displacement distance of the machining target object 100 between the point of the first intensity (first point) and the point of the third intensity (third point) is the thickness of the coating layer 120.

In a case where the machining target object 100 is displaced beyond the third point, the laser irradiation region 200 is largely blocked by the machining target object 100. Accordingly, the intensity of light reaching the outside of the irradiation region 200 decreases to a value smaller than at any of the points described above (region to the right of (C) in FIG. 6). In the present embodiment, such a small value is “end threshold”.

Subsequently, when the end condition is satisfied (s150: YES), the thickness of the coating layer 120 is detected based on the transition of the light intensity recorded so far (s160). Here, in a case where the predetermined first intensity, the second intensity smaller than the first intensity by a predetermined threshold or more, and the third intensity larger than the first intensity are detected in order as the transition of the light intensity, the distance of displacement of the machining target object 100 between the points of detection of the first intensity and the third intensity is detected as the thickness of the coating layer 120 applied to the corner portion 110.

In this step, in a case where the first intensity, the second intensity, and the third intensity are not detected in order as the transition of the light intensity, a notification as error processing that the machining target object is not the machining target object 100 where the coating layer 120 is formed, the coating layer 120 has become abnormal, or the like is given via an interface (display device or communication device, not illustrated).

In this manner, this thickness detection processing ends after s160.

It should be noted that s130 described above is the displacement control means and the displacement control procedure in the invention, s140 is the detection procedure in the invention, and s160 is the detection means and the detection procedure in the invention.

(3) Modification Examples

Although an embodiment of the invention has been described above, the invention is not limited to the above embodiment. It is a matter of course that various forms can be taken insofar as the forms belong to the technical scope of the invention.

For example, in the configuration exemplified in the above embodiment, the optical axis 210 and the machining target object 100 are caused to approach each other by displacing the holding portion 20. However, as the invention, the machining target object 100 has only to relatively approach the optical axis 210 and the irradiation unit 10 may be configured to be displaced. In this case, the detection unit 50 and the irradiation unit 10 may be displaced in conjunction with each other such that the positional relationship of the detection unit 50 with respect to the irradiation region 200 is fixed.

In the configuration exemplified in the above embodiment, the function of thickness detection is integrated into the laser machining apparatus 1 by the laser machining apparatus 1 being provided with the detection unit 50 and the control unit 60 being configured to execute the thickness detection processing. However, this function does not have to be integrated into an apparatus such as the laser machining apparatus 1. For example, in addition to the irradiation unit 10, the holding portion displacement mechanism 40, and the detection unit 50, the control unit 60 that executes the thickness detection processing may be independently provided in the apparatus.

In the configuration exemplified in the above embodiment, the optical axis 210 and the machining target object 100 are caused to approach each other from a state where the optical axis 210 and the machining target object 100 are separated from each other and the thickness of the coating layer 120 is detected based on the light intensity in that process. However, the above embodiment may be configured such that the optical axis 210 and the machining target object 100 are separated from each other from a state where the optical axis 210 and the machining target object 100 are in close proximity to each other or overlap and the thickness of the coating layer 120 is detected based on the light intensity in that process. In a case where the machining target object 100 passes through the third point (FIG. 5(C)), the second point (FIG. 5(B)), and the first point (FIG. 5(A)) and the third intensity, the second intensity, and the first intensity are detected in order in the process of the optical axis 210 and the machining target object 100 being separated from each other in this case, the displacement distance of the machining target object 100 between the point of the first intensity (first point) and the point of the third intensity (third point) may be detected as the thickness of the coating layer 120.

(4) Actions and Effects

In the above embodiment, in a case where the first intensity, the second intensity, and the third intensity are detected in order in the process of the optical axis 210 and the machining target object 100 approaching each other, the relative displacement distance between the point of the first intensity (first point) and the point of the third intensity (third point) is the thickness of the coating layer 120. In the above embodiment, the thickness of the coating layer 120 can be detected based on the transition of the light intensity and the relative displacement distance of the machining target object 100.

In the above embodiment, the transition of the light intensity and the relative displacement distance of the machining target object 100 can be specified based on the function of the laser machining apparatus 1, and thus the thickness of the coating layer 120 can be confirmed without resetting the machining target object in a measuring device for that purpose. As a result, the work up to the actual machining can be simplified.

### INDUSTRIAL APPLICABILITY

The laser machining apparatus, the thickness detection method, and the thickness detection device of the invention can be used for detecting the thickness of a coating layer with regard to a machining target object having the coating layer on a corner portion.

### EXPLANATIONS OF LETTERS OR NUMERALS

1 LASER MACHINING APPARATUS

10 IRRADIATION UNIT

11 OSCILLATOR

13 VIBRATION ADJUSTER

14 POLARIZING ELEMENT

15 ATTENUATOR (ATT)

17 BEAM EXPANDER (EXP)

19 OPTICAL LENS

20 HOLDING PORTION

30 IRRADIATION UNIT DISPLACEMENT MECHANISM

31 MECHANISM MAIN BODY

33 DRIVE UNIT

40 HOLDING PORTION DISPLACEMENT MECHANISM

41 MECHANISM MAIN BODY

43 DRIVE UNIT

50 DETECTION UNIT

60 CONTROL UNIT

61 MEMORY

100 MACHINING TARGET OBJECT

110 CORNER PORTION

120 COATING LAYER

200 IRRADIATION REGION

210 OPTICAL AXIS

1. A laser processing apparatus configured to perform laser machining on a corner portion of a machining target object by causing the corner portion to be relatively displaced toward a laser, the laser being emitted such that an optical axis of the laser extends in a predetermined direction, the corner portion being formed by a plurality of adjacent surfaces of the machining target object and including a coating layer comprising a light-transmissive material, the laser processing apparatus comprising:
displacement control means for controlling an actuator to relatively displace the machining target object along a direction intersecting the optical axis with respect to the laser such that the machining target object becomes relatively close to or away from the optical axis;
a detection unit provided at a position at least outside an irradiation region of the laser, the irradiation region extending in a tubular shape in a plan view intersecting the optical axis, the detection unit being configured to detect intensity of light reaching the position; and
detection means for detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection unit while the machining target object becomes relatively close to or away from the optical axis.

2. The laser processing apparatus according to claim 1, wherein the detection unit is provided at the position at least outside the irradiation region extending in the tubular shape in the laser in the plan view intersecting the optical axis with the position in a region opposite to an irradiation unit in a case where a space extending along the optical axis is divided into two by the machining target object.

3. A thickness detection method comprising:
a displacement control procedure of causing a machining target object to become relatively close to or away from an optical axis of a laser, the laser being emitted such that an optical axis of the laser extends in a predetermined direction in a state where a corner portion of the machining target object is directed to the laser side, the corner portion being formed by a plurality of adjacent surfaces of the machining target object and including a coating layer comprising a light-transmissive material;
a detection procedure of detecting intensity of light reaching a position at the position at least outside an irradiation region of the laser, the irradiation region extending in a tubular shape in a plan view intersecting the optical axis; and
a detection procedure of detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection procedure while the machining target object becomes relatively close to or away from the optical axis.

4. A thickness detection apparatus comprising:
an irradiation unit configured to emit a laser such that an optical axis of the laser extends in a predetermined direction;
an actuator configured to relatively displace a machining target object along a direction intersecting the optical axis with respect to the laser in a state where a corner portion of the machining target object is directed to the laser, the corner portion being formed by a plurality of adjacent surfaces of the machining target object and including a coating layer comprising a light-transmissive material;
displacement control means for controlling the actuator such that the machining target object becomes relatively close to or away from the optical axis;
a detection unit provided at a position at least outside an irradiation region of the laser, the irradiation region extending in a tubular shape in a plan view intersecting the optical axis and detecting intensity of light reaching the position; and
detection means for detecting a distance of relative displacement of the machining target object between points of detection of a first intensity and a third intensity as a thickness of the coating layer in the corner portion in a case where the predetermined first intensity, a second intensity smaller than the first intensity by a predetermined threshold or more, and the third intensity larger than the first intensity are detected in order by the detection unit while the machining target object becomes relatively close to or away from the optical axis.
